(19) United States
(12) Patent Application Publication
(10) Pub. No.: US 2022/0292077 A1
(43) Pub. Date: Sep. 15, 2022

(54) SCALABLE INTERACTIVE DATA COLLECTION SYSTEM

(71) Applicant: TELOSTOUCH INC., Toronto (CA)

(72) Inventors: Jad CHEHLAWI, Toronto (CA); Arsene Toumani NGUELOHE, Toronto (CA)

(21) Appl. No.: 17/635,633

(22) PCT Filed: Aug. 17, 2020
(86) PCT No.: PCT/IB2020/057740

§ 371 Date: Feb. 15, 2022

Related U.S. Application Data
(60) Provisional application No. 62/887,192, filed on Aug. 15, 2019.

(51) Int. Cl. G06F 16/23

(52) U.S. Cl. CPC G06F 16/2365; G06F 16/2358

(57) ABSTRACT

A data collection method includes: storing a set of target profiles each defining a plurality of attributes corresponding to a respective target device; obtaining a selection of a subset of the target devices; generating, based on an engagement data object definition, a plurality of engagement data objects each corresponding to one of the subset of target devices, wherein the engagement data objects contain an input element corresponding to one of the attributes; transmitting the engagement data objects to respective ones of the subset of target devices; receiving, from the subset of target devices, response data corresponding to the engagement data objects; and updating the target profiles corresponding to the subset of target devices according to the response data.

### CROSS-REFERENCE TO RELATED APPLICATION

This application claims priority from U.S. provisional application No. 62/887192, filed Aug. 15, 2019, the contents of which is incorporated herein by reference.

### FIELD

The specification relates generally to data collection systems, and specifically to a scalable interactive data collection system.

### BACKGROUND

Various scenarios involve the collection of data defining attributes of the entity from which the data is collected. For example, providers of professional services (e.g. financial advisers, accountants, lawyers and the like) may seek to collect data defining attributes of customers employing such services. The data collected may be employed to alter and personalize the delivery of the relevant professional service(s), for example.

Data collection in the above scenarios is subject to various constraints. For example, a given provider of professional services typically interacts with a plurality of customer entities in a one-to-many arrangement. Further, the effectiveness of interactions between the provider and the customer entities, in terms of collecting accurate data defining customer attributes, may depend on the relevance and timeliness of information transmitted to customer entities to initiate such interactions. That is, the data collection process may be subject to a scale constraint, time constraint, as well as relevance constraint. Those requirements may conflict with each other (e.g. deploying data collection interactions at scale may reduce the relevance of such interactions to individual customer entities).

As a result of the above-mentioned conflicting constraints, certain existing data collection mechanisms are insufficiently scalable, insufficiently relevant (which may lead to reduced volume and accuracy of collected data), or both.

### SUMMARY

An aspect of the specification provides a data collection method, comprising: storing a set of target profiles each defining a plurality of attributes corresponding to a respective target device; obtaining a selection of a subset of the target devices; generating, based on an engagement data object definition, a plurality of engagement data objects each corresponding to one of the subset of target devices, wherein the engagement data objects contain an input element associated with one of the attributes; transmitting the engagement data objects to respective ones of the subset of target devices; receiving, from the subset of target devices, response data corresponding to the engagement data objects; and updating the target profiles corresponding to the subset of target devices according to the response data.

Another aspect of the specification provides a computing device, comprising: a communications interface; a memory to store a set of target profiles each defining a plurality of attributes corresponding to a respective target device; and a processor configured to: obtain a selection of a subset of the target devices; generate, based on an engagement data object definition, a plurality of engagement data objects each corresponding to one of the subset of target devices, wherein the engagement data objects contain an input element associated with one of the attributes; transmit, via the communications interface, the engagement data objects to respective ones of the subset of target devices; receive, from the subset of target devices, response data corresponding to the engagement data objects; and update the target profiles corresponding to the subset of target devices according to the response data.

### BRIEF DESCRIPTIONS OF THE DRAWINGS

Embodiments are described with reference to the following figures.

FIG. 1 is a block diagram of a scalable interactive data collection system.

FIG. 2 is a block diagram of certain components of the engagement subsystem of the system of FIG. 1.

FIG. 3 is a diagram of certain components of the data collection application of FIG. 2.

FIG. 4 is a flowchart of a data collection method.

FIG. 5 is a diagram of an example engagement data object definition.

### DETAILED DESCRIPTION

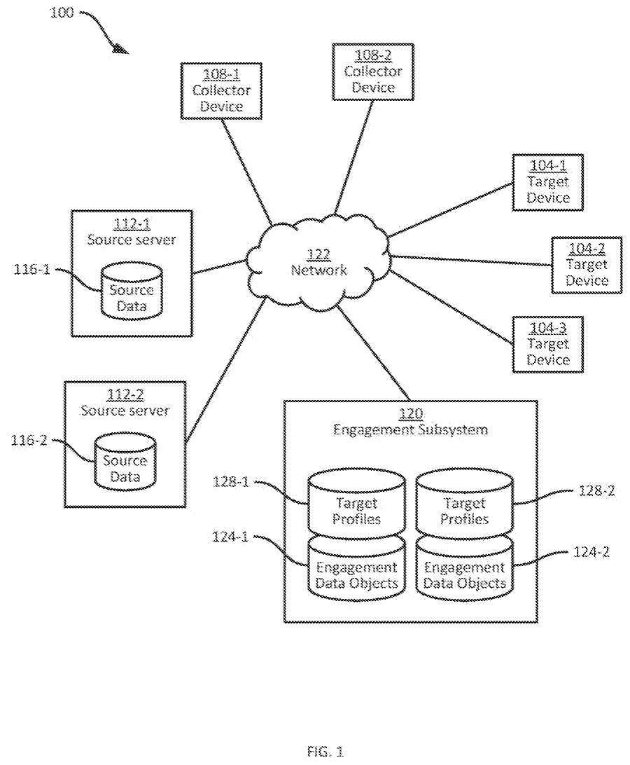

FIG. 1 illustrates a scalable interactive data collection system 100. In general, the system 100 enables the collection of arbitrarily-defined data from data collection targets. In the present example, the data collection targets are operators of target computing devices 104, three examples 104-1, 104-2, and 104-3 of which are illustrated in FIG. 1. The target devices 104 (which may also be referred to as client devices) can be smart phones, tablet computers, desktop computers, or the like. Each target device 104 is operated by a distinct data collection target, such as a customer of a financial institution or other service provider. Interactions between the data collection targets (via the target devices 104) and such service providers may be mediated by data collectors that operate collector computing devices. Two example collector devices 108-1 and 108-2 are illustrated in FIG. 1. The collector devices 108 may also be referred to as advisor devices.

The data collectors may be financial advisers or the like, responsible for the provision of the above-mentioned services to the data collection targets on behalf of the financial institutions or other organizations, referred to generally as source entities that operator source servers 112 herein (two example source servers 112-1 and 112-2 are shown in FIG. 1). The data collectors, and therefore the collector devices 108, may be associated with specific source servers 112, or with multiple source servers 112. In the present example, it is assumed that the collector device 108-1 is associated with the source server 112-1, and the collector device 108-2 is associated with the source server 112-2 (e.g. the operators of the collector devices 108-1 and 108-2 are employees of the source entities operating the servers 112-1 and 112-2, respectively).

As will now be apparent to those skilled in the art, the provision of various services, particularly professional services such as financial advice, may be based in part on data defining various attributes of the data collection targets. In the context of the provision of financial services, such attributes may include asset identifiers, security values and general investment environment, investment preferences, objectives and behaviour, identifying data such as names, dates of birth and the like, risk profile, and so on. Such attributes may inform which particular services or products are offered or recommended to the customers, for example.

Although the system 100 is discussed herein in the context of its deployment to support the provision of financial advice, the system 100 may also be deployed to support a wide variety of other contexts, including other professional services (e.g. accounting, legal services and the like). For example, the system 100 may be deployed for use by a human resources department to manage communications with employees of an organization.

The source servers 112 may maintain respective source data repositories 116-1, 116-2 containing some of the above-mentioned customer data. The servers 112 may implement, for example, customer relationship management (CRM) software to populate and maintain the repositories 116, and to make the data therein available to the collector devices 108. Obtaining timely and accurate customer attributes corresponding to the target devices 104, however, may be challenging.

In particular, customer attributes corresponding to the target devices 104 (as proxies for the customers themselves) are typically obtained from the target devices 104. To obtain such data from the target devices 104, the collector devices 108 and/or the servers 112 may be configured to engage with the target devices 104 to prompt the target devices 104 to provide certain data. Such data collection may be done manually, e.g. by the operators of the collector devices 108, but such manual data collection is time-consuming given that a single collector device 108 may be required to collect data from a significantly larger number of target devices 104. Some previous systems address this scale-based constraint by implementing automated marketing tools, such as mass email distribution. However, processing the output of such mechanisms (that is, the data received from target devices 104) remains a technical challenge.

In particular, any responses received from target devices 104 are typically processed manually in order to update the source data repositories 116, introducing a further scale-based constraint. In addition, return emails and other similar mechanisms of communication may lack detailed metadata, and repositories 116 may therefore be updated only on the basis of periodic, self-reported response data from the target devices 104. Such data may be inaccurate, and manual processing of the response data to update repositories 116 may introduce further inaccuracy. As will be apparent, inaccurate and/or incomplete data in the repositories 116 may render outgoing correspondence (such as the above-mentioned emails) less timely and/or relevant to each individual target device 104, which can result in lower responsiveness and/or accuracy of self-reported data.

To address the above challenges, the system 100 also includes an engagement subsystem 120 that is configured to intermediate between the servers 112, the collector devices 108, and the target devices 104. The engagement subsystem 120, as will be described in greater detail below, generates and transmits to the target devices 104 (e.g. a controllable subset of the target devices 104) one or more engagement data objects. The selection of target device 104 subsets, and of engagement data objects for transmission to the target devices 104, is enabled via communication between the collector devices 108 and the subsystem 120 via a network 122 (e.g. any suitable combination of local and wide area networks, including the Internet). The collector devices 108 may also control the creation of new engagement data objects by communication with the subsystem 120.

The engagement data objects, which may also be referred to as touchpoints, are structured messages containing interface elements and other content employed to prompt the target devices 104 to provide data to the engagement subsystem 120. In other words, the engagement data objects are data collection prompts. Having received the engagement data objects via the network 122, the target devices 104 can provide response data to the subsystem 120 for processing and storage. The structure of the engagement data objects enables the subsystem 120 to at least partially automate the interpretation of response data collected from the target devices 104, and therefore to automatically generate updated target attributes, which may be provided to the servers 112, the collector devices 108, or both.

Further, the delivery of engagement data objects to the target devices 104 and the receipt of response data from the target devices 104 is arranged so as to enable the subsystem 120 to derive certain target attributes beyond those that are solely self-reported (i.e. explicitly contained within the response data from the target devices 104).

In the present example, the engagement subsystem 120 maintains distinct repositories 124-1 and 124-2 of engagement data objects, corresponding to the respective servers 112-1 and 112-2. The subsystem 120 also maintains target profile data, which may also be referred to as customer profile data. Specifically, the subsystem 120 as illustrated maintains a target profile repository 128-1 corresponding to the server 112-1, and a target profile repository 128-2 corresponding to the server 112-2. In other examples, however, the system 100 may include multiple distinct subsystems 120 (e.g. one subsystem 120 per source entity), in which case each subsystem 120 need only contain a single repository 124 and a single repository 128.

The target profile repositories 128 may be populated with data from the source repositories 116-1 and 116-2, respectively. However, as will be apparent in the discussion below, the target profile repositories 128 may also be updated, via the use of engagement data objects, to contain data extending beyond that in the source repositories 116. Such additional and/or updated data may be provided to the servers 112, or accessed directly by the collector devices 108.

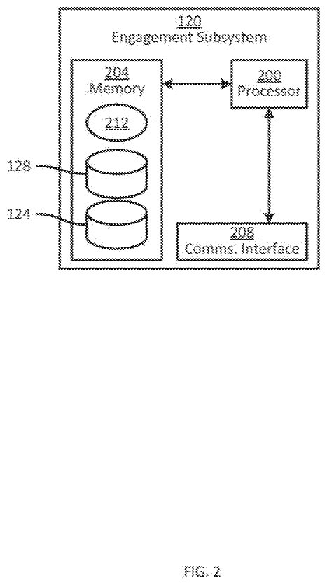

Referring to FIG. 2, a block diagram of certain internal components of the subsystem 120 is illustrated. Although the subsystem 120 is shown as a single computing device in the present example, in other examples the subsystem 120 can be implemented in a distributed manner. In some examples, the subsystem 120 can be deployed on one or more of the servers 112 (e.g. co-hosted with the servers 112).

The subsystem 120, in this example, includes a central processing unit (CPU), which may also be referred to as a processor 200 or a controller 200. The processor 200 is interconnected with a non-transitory computer readable storage medium, such as a memory 204. The memory 204 includes any suitable combination of volatile memory (e.g. Random Access Memory (RAM)) and non-volatile memory (e.g. read only memory (ROM), Electrically Erasable Programmable Read Only Memory (EEPROM), flash) memory. The processor 200 and the memory 204 each comprise one or more integrated circuits (ICs).

The engagement subsystem 120 also includes a communications interface 208, enabling the subsystem 120 to exchange data with other computing devices, e.g. via the network 122. The communications interface 208 therefore includes any suitable hardware (e.g. transmitters, receivers, network interface controllers and the like) allowing the subsystem 120 to communicate over the network 122.

The memory 204 stores the repositories 124 and 128 as noted in connection with FIG. 1, as well as a set of computer-readable instructions in the form of a data collection application 212. The application 212, when executed by the processor 200, configures the subsystem 120 to perform various functions related to the creation, storage and transmission of engagement data objects, and the processing of response data obtained from target devices 104 in response to engagement data objects.

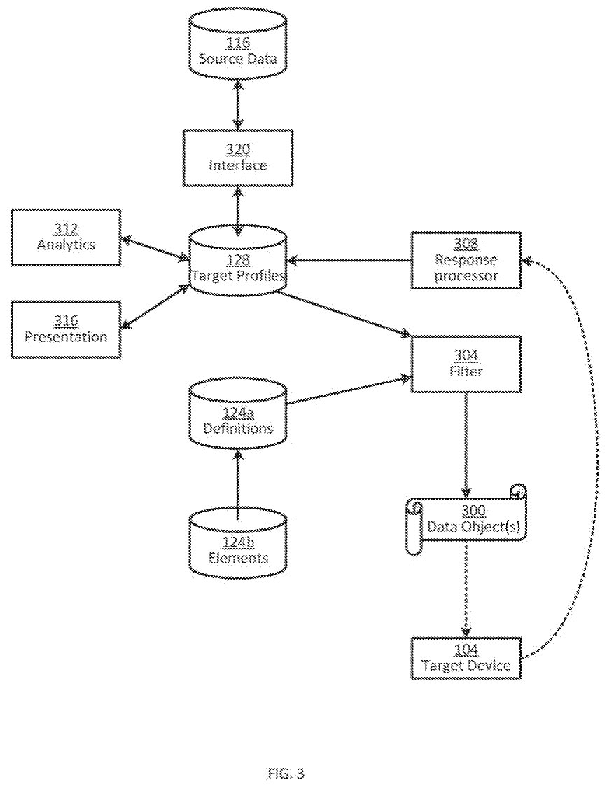

Turning to FIG. 3, various components of the application 212 are illustrated. As will be apparent, the functionality of the application 212 need not be implemented as shown in FIG. 3 in other examples. For example, the application 212 may be arranged in a distinct set of modules from that shown in FIG. 3, or as multiple separate applications.

In general, the application 212 is configured to generate and transmit instances of an engagement data object 300 to at least one target device 104. To select and generate the engagement data object 300, the application 212 employs data from the target profiles 128, and a data object definition from a repository of definitions 124a. In particular, as illustrated in FIG. 3, the repository 124 mentioned in connection with FIG. 1 may be implemented as two repositories—the data object definitions repository 124a, and a repository of data object elements repository 124b. Each data object definition specifies a set of elements that make up the data object. The elements can include multimedia content (e.g. pre-recorded video, text, images and the like), as well as interactive content (e.g. selectable multi-buttons, editable text fields with prompts or other descriptive information, and the like). The elements can also include dynamic target-specific fields, where information from the target profiles 128 is inserted (e.g. a name of a customer operating a given target device 104).

The definition for a given data object may specify not only the elements contained in the data object, but also the layout of those elements, and a hierarchy of presentation of the elements. For example, an engagement data object may include a set of selectable options, and one or more further sets of selectable options, from which one set is selected for presentation at the target device 104 based on which of the first set of options is selected.

As will now be apparent, storage of the elements in the repository 124b enables the re-use of elements across multiple data object definitions in the repository 124a. The data object definitions may, for example, simply refer to elements from the repository 124b. Thus, a given element may need to be defined only once to be used in multiple engagement data object definitions.

The selection of a given subset of target devices 104 to which the data object 300 will be transmitted may be implemented by a filter module 304 of the application 212. The filter module 304 may store a set of filter criteria corresponding to target attributes from the target profiles 128. For example, certain attributes such as target dates of birth, total asset value, time passed since previous data object transmission, and the like, may be designated as filter criteria. The filter module 304 is configured to receive, from a data collector device 108, filter parameters corresponding to at least one of the filter criteria (e.g. the data collector device 108 may specify a total asset value threshold, and a minimum time period since a previous data object transmission). The filter module 304 may then retrieve from the target profiles 128 a subset of profiles that satisfy the filter parameters. The retrieved profiles correspond to the target devices 104 to which the engagement data object will be transmitted. Further, the retrieved profiles may be employed to generate instances of the engagement data object, and to address the engagement data object instances (e.g. based on network identifiers of the target devices 104, account names, phone numbers or the like).

The filter module 304 may also enable the data collector devices 108 to search the data object definitions repository 124a, e.g. based on constituent elements, definition names, or the like. Upon retrieval of the target profiles mentioned above, and a selected data object definition, instances of the relevant data object 300 are generated (one instance per selected target profile). Generation of the data object instances, as will now be apparent, may include substituting profile-specific data into dynamic target-specific elements as mentioned earlier.

Following generation of the data object instances 300, the data object(s) 300 are transmitted to the selected target devices 104 from the subsystem 120 (e.g. via the network 122). The target devices 104 may present the data object 300 thereon (e.g. via displays, speakers and the like), and receive selections or other input, based on the elements included in the data object 300. The selections or other input may be generally referred to as response data.

The response data is received at the subsystem 120 via a response processor 308 of the application 212. The response processor 308 can be configured to extract profile data from the response data, for example based on a stored mapping between data object elements and attributes from the target profiles 128. That is, portions of the data objects 300 may explicitly indicate which portion of a target profile those portions are relevant to, enabling at least partially automated consumption of response data to update the target profiles 128.

The application 212 also includes an analytics module 312, and a presentation module 316. The analytics module 312 is configured to execute various processes to derive updated target attributes from profile data. That is, while certain target attributes may be updated directly from response data (e.g. expiry dates of drivers' licenses or the like), other target attributes may be derived or augmented from a plurality of other target attributes. For example, the risk profile for a given customer may be augmented from various other attributes, such as response metadata (e.g. time of day at which response data is received, time elapsed between transmission of data objects and receipt of response data, self-reported risk tolerance, and the like). The derived attributes can be returned to the target profile repository 128 for storage.

The presentation module 316 is configured to present data to the data collector devices 108, via interfaces such as reports, dashboards, timelines and the like. That is, the presentation module 316 may maintain templates for the above-mentioned interfaces. The data collector devices 108 may alter the templates, e.g. by selecting attributes from the target profiles 128 for inclusion or omission from the interfaces.

As noted earlier, the contents of the target profiles 128 may be seeded periodically (e.g. daily or at any other suitable frequency) with data from the source repositories 116. To that end, the application 212 can include an interface 320 configured to interact with the source repositories 116. The interface 320 may, for example, implement an application programming interface (API) exposed by the source repositories, and may store a mapping between the source repository schema and the schema employed by the target profile repository 128.

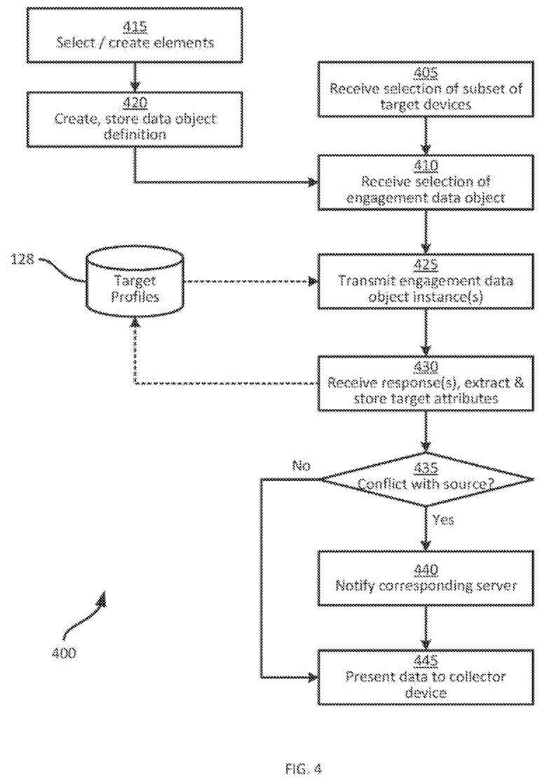

Turning to FIG. 4, the operation of the subsystem 120 will be discussed in greater detail, with reference to a method 400 of scalable interactive data collection. The method 400 will be described in conjunction with its performance by the subsystem 120, and in particular via execution of the application 212 by the processor 200.

At block 405, the subsystem 120 is configured to receive a selection of a subset of target devices 104 from the target devices represented in the profile repository 128. As noted earlier, selection of the subset of target devices 104 can be performed via interaction between a collector device 108 and the subsystem 120 to provide filter parameters that correspond to filter criteria. For example, the filter module 304 can present filter criteria such as locations, birth dates, and the like (each of which correspond to attributes represented in the repository 128) to the collector device 108. The collector device 108 can, in turn, specify filter parameters for at least one of the filter criteria (other filter criteria may be left blank). In some examples, the collector device 108 may also search by target device identifier (e.g. customer name), or select target devices 104 from an unfiltered list.

At block 410, having received the selection of target devices at block 405, the subsystem 120 is configured to receive a selection of an engagement data object from the repository 124. For example, the subsystem 120 can present to the collector device 108 a list of available data object definitions from the repository 124, and receive a selection of one definition from the device 108. In other examples, the subsystem 120 can automatically generate at least one of the selections at blocks 405 and 410. For example, the subsystem 120 can be configured to detect upcoming events, such as the expiry of a predetermined time period since contact information for the subset of target devices 104 was updated or confirmed. In response to such a detection, the subsystem 120 can also automatically select a data object definition containing elements prompting the target devices 104 to update or confirm their contact information. In some examples, the performance of block 410 may precede the performance of block 405.

As will be apparent, data object definitions may be created prior to selection at block 410. Creation of a data object definition may occur separately from the performance of the method 400, or alongside the performance of the method 400. That is, in some examples, a data collector device 108 may provide a target device 104 selection at block 405, and then create a new data object definition prior to performing block 410.

To create a new data object definition, the collector device 108 can select, from the repository 124b, one or more data object elements. The collector device 108 may also create new data object elements for storage in the repository 124b. To create a new data object element, the subsystem 120 can provide an element creation interface to the collector device 108. The collector device 108 can define, for the new element, a type of element (e.g. a content presentation element containing text, multimedia or the like, or an input element defining selectable options), and content for the element. The collector device 108 can also associate the element with a target attribute from the profile repository 128. For example, a selectable list of target attributes may be presented, and an identifier of the selected attributes can be stored as metadata of the element, indicating that response data received in connection with the element is to be employed to update the associated target attribute.

Having created and/or selected data object elements, at block 420 the collector device 108 can define the layout and hierarchy of the selected elements. For example, the data object definition can include timing information defining a sequence in which the selected elements are to be presented, and/or conditions under which each element is to be presented.

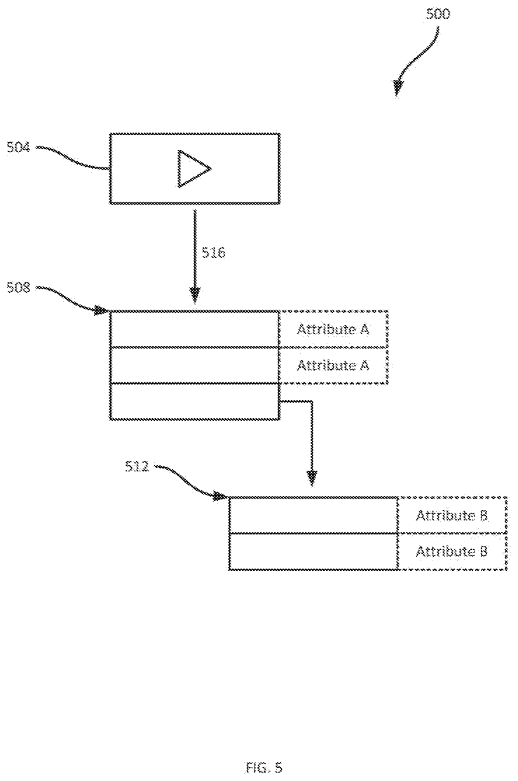

Turning to FIG. 5, an example data object definition 500 is shown. The definition 500 contains three elements 504, 508, and 512. The first element 504 is a multimedia element, such as a video. The second element 508 and the third element 512 each define a plurality of selectable options. The data object definition also includes staging indicators indicating an order in which the elements are to be presented. In particular, the staging indicator 516 indicates that the element 508 is presented after presentation of the element 504. Further the staging indicator 520 indicates that the element 512 is presented only upon selection of the third option of the element 508.

In addition, certain options of the elements 508 and 512 are associated with target attributes from the profile repository 128. In particular, the first two selectable options of the element 508 are associated with a first attribute, while the two selectable options of the element 512 are associated with a second attribute. That is, input received at a target device 104 in connection with a data object generated according to the definition 500 can be employed to automatically update either of two target profile attributes.

Returning to FIG. 4, at block 420 the data object definition is stored in the repository 124a upon completion, and performance of the method 400 proceeds to block 410 as described above.

At block 425, the subsystem 120 is configured to generate and transmit instances of the selected data object definition to the selected target devices 104. In particular, as noted above, an instance of the selected data object definition is generated for each selected target device 104. Generation of the data object instances may include populating the above-mentioned dynamic fields with profile data from the repository 128. The data object instances may be transmitted via the network 122, for example via a communications channel established by an application executing on the target devices 104 configured to interact with the subsystem 120.

At block 430, the subsystem 120 is configured to receive response data from each of the target devices 104 to which the data object instances were transmitted. The subsystem 120 is also configured to extract and store updated target attributes from the response data in the repository 128. Extracting and storing updated target attributes can include, at the response processor 308, extracting input from elements such as the elements 508 and 512 indicating which options were selected or otherwise interacted with at the target device 104, and mapping the response data from those elements to the associated attributes in the repository 128. In other examples, extraction can include deriving or augmenting attributes such as the above-mentioned risk profile by the analytics module 312.

The data extracted at block 430 can be stored in the repository 128, as indicated by the dashed line in FIG. 4. At block 435, the subsystem 120 is configured to determine whether the target profiles of the relevant target devices 104 conflict with the source data. For example, the updated target attributes from block 430 can be compared to the previous contents of the repository 128, or directly to the corresponding contents of the source repository 116 via the interface 320. When the updated target attributes differ from the previous data, the determination at block 435 is affirmative.

Following an affirmative determination at block 435, at block 440 the subsystem 120 transmits a notification, e.g. to the relevant server 112, defining the conflict. The server 112 may implement any of a variety of control mechanisms to update the repository 116 based on the notification.

When the determination at block 435 is negative, or after performing block 440, the subsystem 120 can proceed to block 445. At block 445, the subsystem 120 can present data from the target profile repository 128 to the collector devices 108, e.g. upon request. For example, the subsystem 120 can present one or more dashboards, timelines or the like to a collector device 108.

Those skilled in the art will appreciate that in some embodiments, the functionality of the application 212 may be implemented using pre-programmed hardware or firmware elements (e.g., application specific integrated circuits (ASICs), electrically erasable programmable read-only memories (EEPROMs), etc.), or other related components.

The scope of the claims should not be limited by the embodiments set forth in the above examples, but should be given the broadest interpretation consistent with the description as a whole.

1. A data collection method, comprising:
storing a set of target profiles each defining a plurality of attributes corresponding to a respective target device;
obtaining a selection of a subset of the target devices;
generating, based on an engagement data object definition, a plurality of engagement data objects each corresponding to one of the subset of target devices, wherein the engagement data objects contain an input element associated with one of the attributes;
transmitting the engagement data objects to respective ones of the subset of target devices;
receiving, from the subset of target devices, response data corresponding to the engagement data objects; and
updating the target profiles corresponding to the subset of target devices according to the response data.

2. The method of claim 1, wherein receiving the selection of the subset of the target devices includes automatically generating the selection.

3. The method of claim 1, wherein updating the target profiles includes deriving an updated target attribute based on a plurality of data object elements in the response data.

4. The method of claim 3, wherein updating the target profiles further includes deriving the updated target attributes based on response metadata.

5. The method of claim 1, wherein updating the target profiles includes updating the one of the attributes according to the associated input element.

6. The method of claim 1, further comprising transmitting a notification to a source repository.

7. The method of claim 6, further comprising determining, prior to transmitting the notification, that an updated target attribute conflicts with a source target attribute stored at the source repository.

8. A computing device, comprising:
a communications interface;
a memory to store a set of target profiles each defining a plurality of attributes corresponding to a respective target device; and
a processor configured to:
obtain a selection of a subset of the target devices;
generate, based on an engagement data object definition, a plurality of engagement data objects each corresponding to one of the subset of target devices, wherein the engagement data objects contain an input element associated with one of the attributes;
transmit, via the communications interface, the engagement data objects to respective ones of the subset of target devices;
receive, from the subset of target devices, response data corresponding to the engagement data objects; and
update the target profiles corresponding to the subset of target devices according to the response data.

9. The computing device of claim 8, wherein the processor is configured, to receive the selection of the subset of the target devices, to automatically generate the selection.

10. The computing device of claim 8, wherein the processor is configured, to update the target profiles, to derive an updated target attribute based on a plurality of data object elements in the response data.

11. The computing device of claim 10, wherein the processor is configured, to update the target profiles, to derive the updated target attributes based on response metadata.

12. The computing device of claim 8, wherein the processor is configured, to update the target profiles, to update the one of the attributes according to the associated input element.

13. The computing device of claim 8, wherein the processor is further configured to transmit a notification to a source repository.

14. The computing device of claim 13, wherein the processor is further configured to determine, prior to transmission of the notification, that an updated target attribute conflicts with a source target attribute stored at the source repository.
